(19) United States
(12) Patent Application Publication
(10) Pub. No.: US 2011/0035214 A1
(43) Pub. Date: Feb. 10, 2011

(54) ENCODING DEVICE AND ENCODING METHOD

(75) Inventor: Toshiyuki Morii, Kanagawa (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/936,447

(22) PCT Filed: Apr. 8, 2009
(86) PCT No.: PCT/JP2009/001626

§ 371 Date: Oct. 5, 2010

(30) Foreign Application Priority Data
Apr. 9, 2008 (JP) 2008-101177
Nov. 14, 2008 (JP) 2008-292626

(51) Int. Cl. G10L 19/14

(52) U.S. Cl. 704/225; 704/E19.039

(57) ABSTRACT

Good sound quality as perceived by the ear is obtained even with few information bits. A shape quantizer (111) is comprised of an interval search unit (121) which searches and encodes the pulses in each band of a plurality of divisions of the specified search interval, and a full search unit (122) which searches for pulses over the entire search interval, and quantizes the shape of the input spectrum at the positions and the polarities of a small number of pulses. The interval search unit (121) encodes a pulse searched for in a higher band than the specified frequency with fewer bits than a pulse searched for in another band. The full search unit (122) encodes the pulses positioned in a higher band than the specified frequency with fewer bits than the other pulses. A gain quantizer (112) calculates and quantizes in each band the gain of a pulse searched for by the shaper quantizer (111).

### TECHNICAL FIELD

The present invention relates to a coding apparatus and coding method for encoding speech signals and audio signals.

### BACKGROUND ART

In mobile communication, it is necessary to compress and encode digital information of speech and images for efficient use of radio channel capacity for radio waves and storage media, and many coding and decoding schemes have been developed so far.

Among these, the performance of speech coding technology has been improved significantly by the fundamental scheme of “CELP (Code Excited Linear Prediction),” which models the vocal tract system of speech and skillfully adopts vector quantization. Further, the performance of sound coding technology such as audio coding has been improved significantly by transform coding techniques (such as MPEG-standard ACC and MP3).

On the other hand, a scalable codec, the standardization of which is in progress by ITU-T (International Telecommunication Union-Telecommunication Standardization Sector) and others, is designed to cover from the conventional speech band (which is a band of 300 Hz to 3.4 kHz at 8 kHz sampling) to the wideband (which is a band of 50 Hz to 7 kHz at 16 kHz sampling). Further, in the standardization, it is also necessary to encode frequency band signals of an ultra wideband (which is a band of 10 Hz to 15 kHz at 32 kHz sampling). Accordingly, in a wideband codec, audio has to be encoded in a certain degree, which cannot be supported only by conventional, low-bit-rate speech coding techniques based on the human voice model such as CELP. Now, ITU-T standard G.729.1, declared earlier as a recommendation, uses an audio codec coding scheme of transform coding, to encode speech of wideband or above.

Patent Literature 1 discloses a coding scheme utilizing spectral parameters and pitch parameters, whereby signals acquired by inverse-filtering speech signals by spectral parameters are orthogonally transformed and encoded, and, as an example of coding, further discloses a coding method based on codebooks of an algebraic structure.

Patent Literature 2 discloses a coding scheme of dividing a speech signal into the linear prediction parameters and the residual components, performing orthogonal transform of residual components, and normalizing the residual waveform by the power and then quantizing the gain and the normalized residue. Further, Patent Literature 2 discloses vector quantization as a quantization method for normalized residue.

Non-Patent Literature 1 discloses a coding method based on an algebraic codebook improving excitation spectrums in TCX (i.e. a fundamental coding scheme modeled by filtering of an excitation subjected to transform coding and spectral parameters), and this coding method is adopted in ITU-T standard G.729.1.

Non-Patent Literature 2 discloses description of the MPEG-standard scheme, “TC-WVQ.” This scheme is also used to transform linear prediction residue and perform vector quantization of a spectrum, using DCT (Discrete Cosine Transform) as an orthogonal transform method.

With the above four conventional techniques, upon coding, it is possible to use quantization of spectral parameters such as linear prediction parameters, which is an efficient coding element technique for speech signals, and realize efficient audio coding and a low bit rate.

### CITATION LIST

### Patent Literature

PTL 1: Japanese Patent Application Laid-Open No. HEI10-260698
PTL 2: Japanese Patent Application Laid-Open No. HEI07-261800

### Non-Patent Literature

### NPL 1: Xie, Adou1, “EMBEDDED ALGEBRAIC VECTOR QUANTIZERS (EAVQ) WITH APPLICATION TO WIDEBAND SPEECH CODING,” ICASSP'96

NPL 2: Moriya, Honda, “Transform Coding of Speech Using a Weighted Vector Quantizer,” IEEE journal on selected areas in communications, Vol. 6, No. 2, February 1988

### SUMMARY OF INVENTION

### Technical Problem

However, the number of bits to be assigned is small especially in a relatively lower layer of a scalable codec, and, consequently, the performance of excitation transform coding is not sufficient. For example, in ITU-T standard G.729.1, although the bit rate is 12 kbps up to a second layer of the telephone band (300 Hz to 3.4 kHz), only 2 kbps is assigned to a third layer supporting the next wideband (50 Hz to 7 kHz). Thus, when there are few information bits, it is not possible to achieve sufficient perceptual performance by a method of encoding a spectrum acquired by an orthogonal transform, with vector quantization using a codebook.

Further, as for above G.729.1, in a scalable codec to implement extension standardization, in the same way as above, only a low bit rate of 2 kbps is assigned to an enhancement layer in which the bit rate increases from a wideband (50 Hz to 7 kHz) to an ultra wideband (10 Hz to 15 kHz). That is, despite the 8 kHz increase of the band, it is not possible to secure a sufficient bit rate.

It is therefore an object of the present invention to provide a coding apparatus and coding method that can achieve good perceptual quality even when there are few information bits.

### Solution to Problem

The coding apparatus of the present invention employs a configuration having: a shape quantizing section that encodes a shape of a frequency spectrum; and a gain quantizing section that encodes a gain of the frequency spectrum, in which the shape quantizing section includes: an interval search section that searches for a first waveform in each of a plurality of bands dividing a predetermined search interval, and encodes the first waveform searched out in a predetermined band, by a smaller number of bits than other first waveforms; and a thorough search section that searches for a second waveform over the predetermined search interval, and, when the second waveform located in the predetermined band satisfies a predetermined condition, encodes a position near a position of the second waveform located in the predetermined band.

The coding method of the present invention includes: a shape quantizing step of encoding a shape of a frequency spectrum; and a gain quantizing step of encoding a gain of the frequency spectrum, in which the shape quantizing step includes: an interval search step of searching for a first waveform in each of a plurality of bands dividing a predetermined search interval, and encoding the first waveform searched out in a predetermined band, by a smaller number of bits than other first waveforms; and a thorough search step of searching for a second waveform over the predetermined search interval, and, when the second waveform located in the predetermined band satisfies a predetermined condition, encodes a position nearby a position of the second waveform located in the predetermined band.

### ADVANTAGEOUS EFFECTS OF INVENTION

According to the present invention, it is possible to accurately encode frequency (positions) where energy is present, so that it is possible to improve qualitative performance, which is unique to spectrum coding, and provide good sound quality even at a low bit rate.

### BRIEF DESCRIPTION OF DRAWINGS

FIG. 1 is a block diagram showing the configuration of a speech coding apparatus according to Embodiments 1 and 2 of the present invention;

FIG. 2 is a block diagram showing the configuration of a speech decoding apparatus according to Embodiments 1 and 2 of the present invention;

FIG. 3 is a flowchart showing a search algorithm of an interval search section according to Embodiment 1 of the present invention;

FIG. 4 shows an example of a spectrum represented by pulses searched out in an interval search section according to Embodiment 1 of the present invention;

FIG. 5 is a flowchart showing a search algorithm of a thorough search section according to Embodiment 1 of the present invention;

FIG. 6 is a flowchart showing a search algorithm of a thorough search section according to Embodiment 1 of the present invention;

FIG. 7 shows an example of a coding result of pulse positions searched out by thorough search;

FIG. 8 shows an example of a spectrum represented by pulses searched out in an interval search section and thorough search section according to Embodiment 1 of the present invention;

FIG. 9 is a flowchart showing a decoding algorithm of a spectrum decoding section according to Embodiment 1 of the present invention;

FIG. 10 is a flowchart showing a search algorithm of an interval search section according to Embodiment 2 of the present invention;

FIG. 11 is a flowchart showing a search algorithm of a thorough search section according to Embodiment 2 of the present invention; and

FIG. 12 is a flowchart showing a search algorithm of a thorough search section according to Embodiment 2 of the present invention.

### DESCRIPTION OF EMBODIMENTS

Human perception perceives voltage components (i.e. the signal value of a digital signal) logarithmically, and, consequently, in a case where speech signals are converted into the frequency domain and encoded, has a characteristic of having difficulty recognizing frequency accurately and perceptually in higher spectral components. For example, human perception perceives the same amount of increase (twice) between a case where the signal value increases from 10 dB to 20 dB and a case where the signal value increases from 20 dB to 40 dB. In contrast, although human perception can perceive the difference of signal values between 20 dB and 21 dB, it cannot perceive the difference between 1000 dB and 1001 dB.

The present invention has focused on this point and arrived at the present invention. That is, the present invention adopts a model of encoding a frequency spectrum by a small number of pulses, and, in coding for transforming a coding speech signal (time-series vector) into the frequency domain by an orthogonal transform, encodes a spectrum and then performs coding at a low bit rate with reduced accuracy of frequency information of high frequency components.

An embodiment of the present invention will be explained below with reference to the accompanying drawings. Here, an example case will be described with the present embodiment, using a speech coding apparatus and a speech decoding apparatus as a coding apparatus and a decoding apparatus, respectively.

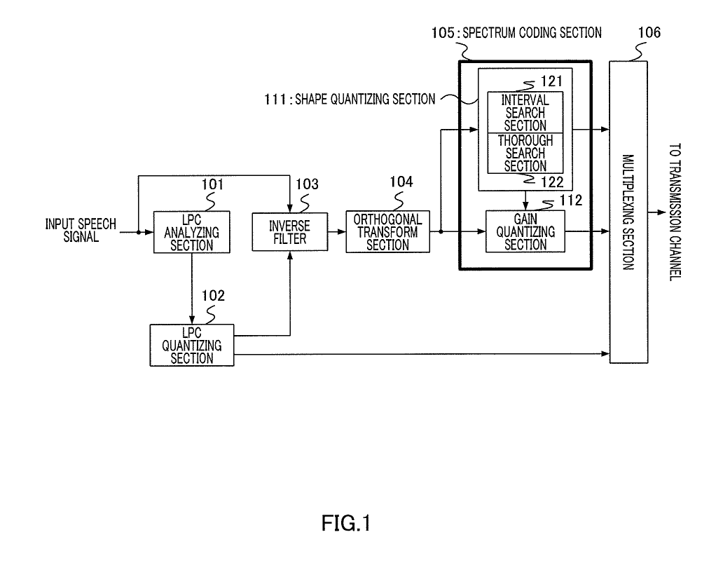

FIG. 1 is a block diagram showing the configuration of a speech coding apparatus according to the present embodiment. The speech coding apparatus shown in FIG. 1 is provided with LPC analyzing section 101, LPC quantizing section 102, inverse filter 103, orthogonal transform section 104, spectrum coding section 105 and multiplexing section 106. Spectrum coding section 105 is provided with shape quantizing section 111 and gain quantizing section 112.

LPC analyzing section 101 performs a linear prediction analysis of an input speech signal and outputs a spectral envelope parameter to LPC quantizing section 102 as an analysis result. LPC quantizing section 102 performs quantization processing of the spectral envelope parameter (LPC: Linear Prediction Coefficient) outputted from LPC analyzing section 101, and outputs a code representing the quantized LPC, to multiplexing section 106. Further, LPC quantizing section 102 outputs decoded parameters acquired by decoding the code representing the quantized LPC, to inverse filter 103. Here, the parameter quantization may adopt vector quantization (“VQ”), prediction quantization, multi-stage VQ, split VQ and other modes.

Inverse filter 103 inverse-filters input speech using the decoded parameters and outputs the resulting residual component to orthogonal transform section 104.

Orthogonal transform section 104 applies a match window, such as a sine window, to the residual component, performs an orthogonal transform using MDCT (Modified Discrete Cosine Transform), and outputs a spectrum transformed into the frequency domain (hereinafter “input spectrum”), to spectrum coding section 105. Here, the orthogonal transform may employ other transforms such as the FFT (Fast Fourier Transform), KLT (Karhunen-Loeve Transform) and Wavelet transform, and, although their usage varies, it is possible to transform the residual component into an input spectrum using any of these.

Here, the order of processing may be reversed between inverse filter 103 and orthogonal transform section 104. That is, by dividing an input speech signal subjected to orthogonal transform by the frequency spectrum of an inverse filter (i.e. subtraction on the logarithmic axis), it is possible to provide the same input spectrum.

Spectrum coding section 105 quantizes the spectral shape and gain of the input spectrum separately and outputs the resulting quantization codes to multiplexing section 106. Shape quantizing section 111 quantizes the shape of the input spectrum based on the positions and polarities of a small number of pulses. Here, in coding of pulse positions, shape coding section 111 performs coding with a saved number of bits by reducing the accuracy of position information in the higher frequency band. Gain quantizing section 112 calculates and quantizes the gain of the pulses searched out by shape quantizing section 111, on a per band basis. Shape quantizing section 111 and gain quantizing section 112 will be described later in detail.

Multiplexing section 106 receives as input a code representing the quantized LPC from LPC quantizing section 102 and a code representing the quantized input spectrum from spectrum coding section 105, multiplexes these items of information, and outputs the result to the transmission channel as encoded information.

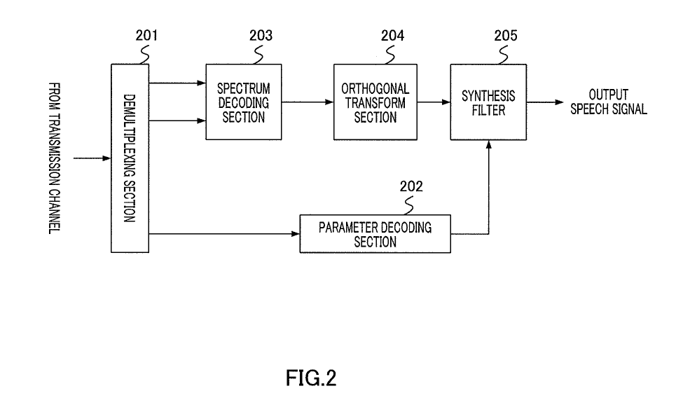

FIG. 2 is a block diagram showing the configuration of a speech decoding apparatus according to the present embodiment. The speech decoding apparatus shown in FIG. 2 is provided with demultiplexing section 201, parameter decoding section 202, spectrum decoding section 203, orthogonal transform section 204 and synthesis filter 205.

Encoded information transmitted from the speech coding apparatus of FIG. 1 is received in the speech decoding apparatus of FIG. 2 and demultiplexed into individual codes in demultiplexing section 201. The code representing the quantized LPC is outputted to parameter decoding section 202, and the code of the input spectrum is outputted to spectrum decoding section 203.

Parameter decoding section 202 decodes the spectral envelope parameter and outputs the resulting decoded parameter to synthesis filter 205.

Spectrum decoding section 203 decodes the shape vector and gain by a method supporting the coding method in spectrum coding section 105 shown in FIG. 1, acquires a decoded spectrum by multiplying the decoded shape vector by the decoded gain, and outputs the decoded spectrum to orthogonal transform section 204.

Orthogonal transform section 204 transforms the decoded spectrum outputted from spectrum decoding section 203 in an opposite way to orthogonal transform section 104 shown in FIG. 1, and outputs the resulting, time-series decoded residual signal to synthesis filter 205.

Synthesis filter 205 provides output speech by applying a synthesis filter to the decoded residual signal outputted from orthogonal transform section 204, using the decoded parameter outputted from parameter decoding section 202.

Here, to reverse the order of processing between inverse filter 103 and orthogonal transform section 104 shown in FIG. 1, the speech decoding apparatus of FIG. 2 performs a multiplication by the frequency spectrum of the decoded parameter (i.e. addition on the logarithmic axis) before performing an orthogonal transform, and then performs an orthogonal transform of the resulting spectrum.

Next, shape quantizing section 111 and gain quantizing section 112 will be explained in detail. Shape quantizing section 111 is provided with interval search section 121 that searches for pulses in each of a plurality of bands into which a predetermined search interval is divided, and thorough search section 122 that searches for pulses over the entire search interval.

Following equation 1 provides the reference of search. Here, in equation 1, E is the coding distortion, sᵢ is the input spectrum, g is the optimal gain, δ is the delta function, and p is the pulse position.

$$\begin{matrix}( Equation 1 ) & \\ E = {\sum }_{i} {\{ {s}_{i} - g δ ( i - p ) \}}^{2} & [ 1 ]\end{matrix}$$

From equation 1 above, the pulse position to minimize the cost function refers to a position in which the absolute value |sₚ| of the input spectrum in each band is maximum, and the polarity refers to a polarity of the input spectrum value in the position of that pulse.

An example case will be explained below where the vector length of an input spectrum is eighty samples and the number of bands is five, and where the spectrum is encoded using eight pulses in total, one pulse from each band and three pulses from the entire band. In this case, the length of each band is sixteen samples. Further, the amplitude of pulses to search for is fixed to “1,” and their polarity is “+” or “−.”

Also, upon shape coding, the number of bits is saved by reducing the accuracy of pulse positions in two high frequency bands. To be more specific, although coding is performed in all positions, positions in two high frequency bands are limited to “odd-numbered” positions in decoding. Here, in a case where a pulse is already present upon decoding, a case is possible where a pulse is placed in an even-numbered position.

Interval search section 121 searches for the position of the maximum energy and the polarity (+/−) in each band, and places one pulse per band. In this example, the number of bands is five, and each band requires four bits (entries of positions: sixteen)×three bands+three bits (entries of positions: eight)×two bands to show the pulse position and one bit to show the polarity (+/−), requiring twenty three information bits in total. Also, if the accuracy in the high frequency bands is not reduced, it requires five (bands)×(four (position) and one (polarity))=twenty-five information bits. Therefore, according to this example, it is possible to save two bits compared to a case of not reducing the accuracy in high frequency bands.

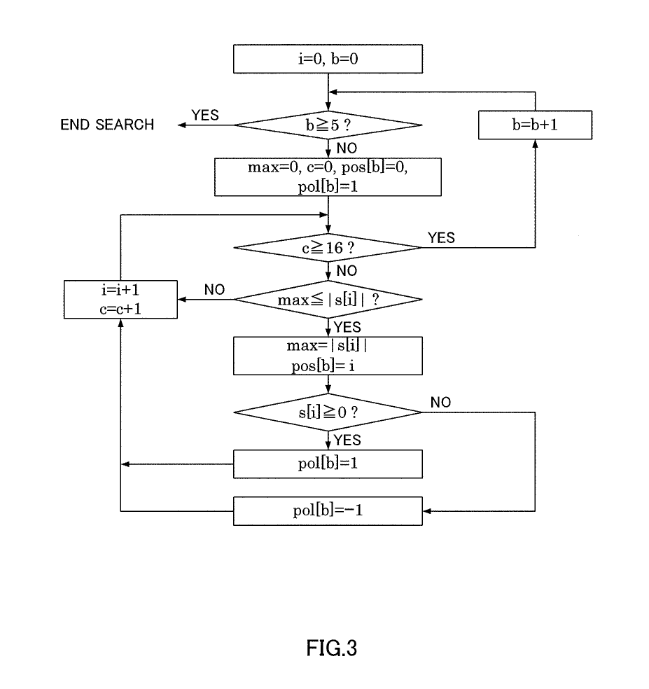

The flow of the search algorithm of interval search section 121 is shown in FIG. 3. Here, the symbols used in the flowchart of FIG. 3 stand for the following.
i: position
b: band number
max: maximum value
c: counter
pos[b]: search result (position)
pol[b]: search result (polarity)
s[i]: input spectrum

As shown in FIG. 3, interval search section 121 calculates the input spectrum s[i] of each sample (0≦c≦15) per band (0≦b≦4), and calculates the maximum value “max.”

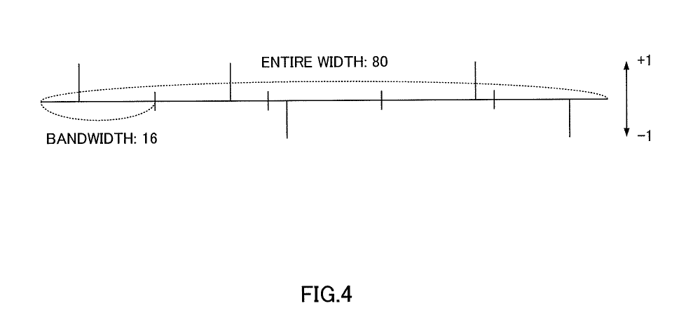

FIG. 4 shows an example of a spectrum represented by pulses searched out by interval search section 121. As shown in FIG. 4, one pulse having an amplitude of “1” and polarity of “+” or “−” is placed in each of five bands each having a bandwidth of sixteen samples.

In other bands than the two high frequency bands, after coding is performed according to the above algorithm, the result of subtracting the value of the first position in each band from pos[b] (i.e. a value between 0 and 15), is used as a position code (four bits). In the two high frequency bands, the result of dividing the same value by 2 (i.e. a value between 0 and 7), is used as a position code (three bits).

Thorough search section 122 searches for the positions to place three pulses over the entire search interval, and encodes the positions and polarities of the pulses. In thorough search section 122, a search is performed according to the following five conditions for accurate position coding with a small amount of information bits and a small amount of calculations.

(1) Two or more pulses are not placed in the same position. In this example, pulses are not placed in the positions in which a pulse is placed in interval search section 121 on a per band basis. With this ingenuity, information bits are not used to represent the amplitude component, so that it is possible to use information bits efficiently.

(2) Pulses are searched for one by one, in order, in an open loop. During a search, according to the rule of (1), pulse positions having been determined, are not subject to search.

(3) In a position search, a position in which a pulse is less preferable to be placed is also encoded as one position.

(4) Given that gain is encoded on a per band basis, pulses are searched for by evaluating coding distortion with respect to the ideal gain of each band.

(5) In the range of high frequency bands to reduce the accuracy of position information, although a pulse searched out by thorough search and a band-specific pulse are allowed to be placed consecutively in an even-numbered position and an odd-numbered position, pulses searched out by thorough search are not allowed to be placed consecutively in an even-numbered position and an odd-numbered position.

Thorough search section 122 performs the following two-step cost evaluation to search for one pulse over the entire input spectrum. First, in the first step, thorough search section 122 evaluates the cost in each band and finds the position and polarity to minimize the cost function. Then, in the second stage, every time the above search is finished in one band, thorough search section 122 evaluates the overall cost and stores the position and polarity of the pulse to minimize the cost, as a final result. This search is performed per band, in order. Further, this search is performed to meet the above conditions (1) to (5). Then, when a search of one pulse is finished, assuming the presence of that pulse in the searched position, a search for the next pulse is performed. This search is performed until a predetermined number of pulses (three pulses in this example) are found, by repeating the above processing.

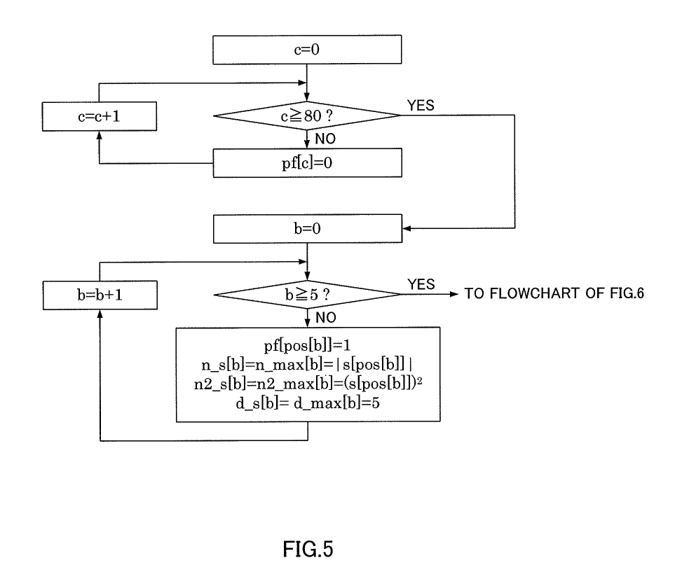

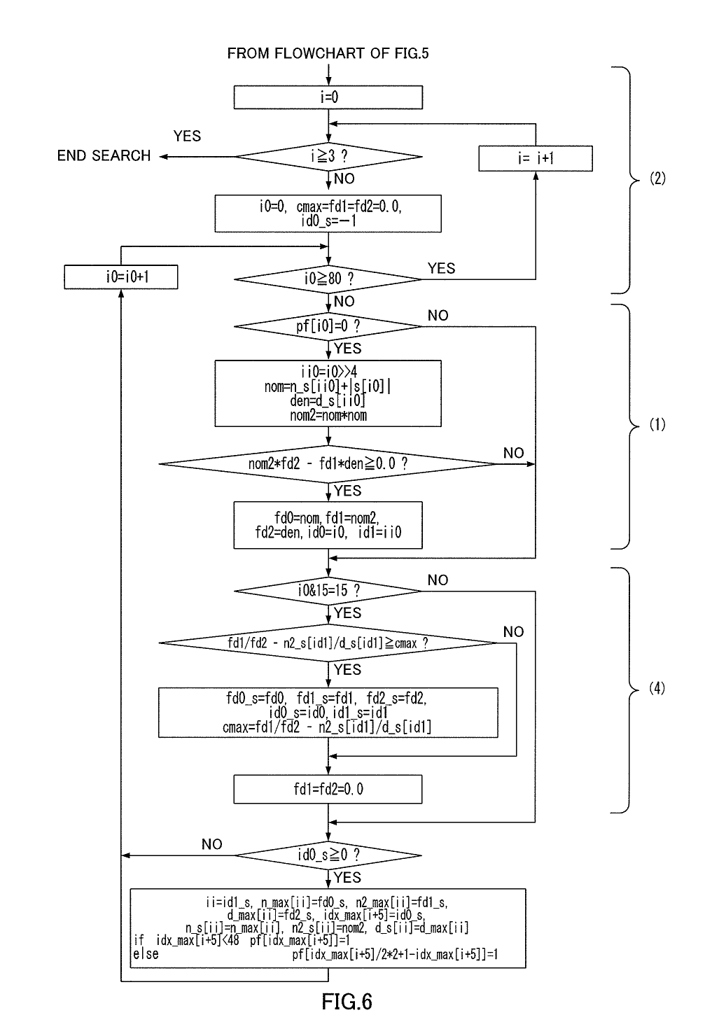

The flow of the search algorithm in thorough search section 122 is shown in FIG. 5. FIG. 5 is a flowchart of preprocessing of a search, and FIG. 6 is a flowchart of the search. Further, the parts corresponding to the above conditions (1), (2) and (4) are shown in the flowchart of FIG. 6.

The symbols used in the flowchart of FIG. 5 stand for the following.
c: counter
pf[*]: pulse presence/non-presence flag
b: band number
pos[*]: search result (position)
n_s[*]: correlation value
n_max[*]: maximum correlation value
n2_s[*]: square correlation value
n2_max[*]: maximum square correlation value
d_s[*]: power value
d_max[*]: maximum power value
s[*]: input spectrum

The symbols used in the flowchart of FIG. 6 stand for the following.
i: pulse number
i0: pulse position
cmax: maximum value of cost function
pf[*]: pulse presence/non-presence flag (0: non-presence,
   1: presence)
ii0: relative pulse position in a band
nom: spectral amplitude
nom2: numerator term (spectral power)
den: denominator term
n_s[*]: relative value
d_s[*]: power value
s[*]: input spectrum
n2_s[*]: square correlation value
n_max[*]: maximum correlation value
n2_max[*]: maximum square correlation value
idx_max[*]: search result of each pulse (position) (here,
idx_max[*] of 0 to 4 is equivalent to pos[b] of FIG. 3)
fd0, fd1, fd2: temporary storage buffer (real number type)
id0, id1: temporary storage buffer (integral number type)
id0_s, id1_s: temporary storage buffer (integral number type)
>>: bit shift (to the right)
&: “and” as a bit sequence

Here, in the search in FIG. 5 and FIG. 6, the case where idx_max[*] stays “−1,” corresponds to the above case of condition (3) where a pulse is less preferable to be placed. A specific example of this is where a spectrum is sufficiently approximated only with pulses searched per band and pulses searched over the entire range, and where further addition of pulses of the same magnitude increases coding distortion proportionally.

Thorough search section 122 encodes polarities of three pulses searched out by thorough search, with 3 (pulses)×1=3 bits. Here, when the position is “−1,” that is, when a pulse is not placed, either polarity can be used. However, the polarity may be used to detect bit error and generally is fixed to either “+” or “−.”

Further, thorough search section 122 encodes position information of pulses searched out by thorough search, taking into account the relationships to band-specific pulses. This will be explained below in detail.

Thorough search section 122 searches for pulses in position candidates other than positions in which a band-specific pulse is placed.

Here, the present embodiment restricts two high frequency bands, such that pulses are placed in odd-numbered positions upon decoding, and therefore a case is possible where a pulse on the decoding side may not be placed in the same position as on the encoding side. For example, when the pulse position in the fourth band is “58,” a code of “5” is given by dividing “10” by 2, where this “10” is given by subtracting the first position in that band, “48,” from “58.” On the decoding side, the position to place a pulse is given by doubling “5” and adding “1” and the first position (i.e. 5×2+1+48=59).

In this case, when a pulse searched out by thorough search is “59,” the position of the pulse searched out in the band and the position of the pulse searched out by thorough search, overlap on the decoding side.

Therefore, with the present embodiment, in order to prevent the position of a pulse searched out in a band and the position of a pulse searched out by thorough search from being overlapped, the band-specific pulse position is fixed, and the thorough pulse position is determined such that the code is different before or after the band-specific pulse position. In this example, pulse positions around “58” in the fourth band are expressed accurately, like “ . . . , 49, 51, 53, 55, 57, 58, 59, 61, 63, and so on.”

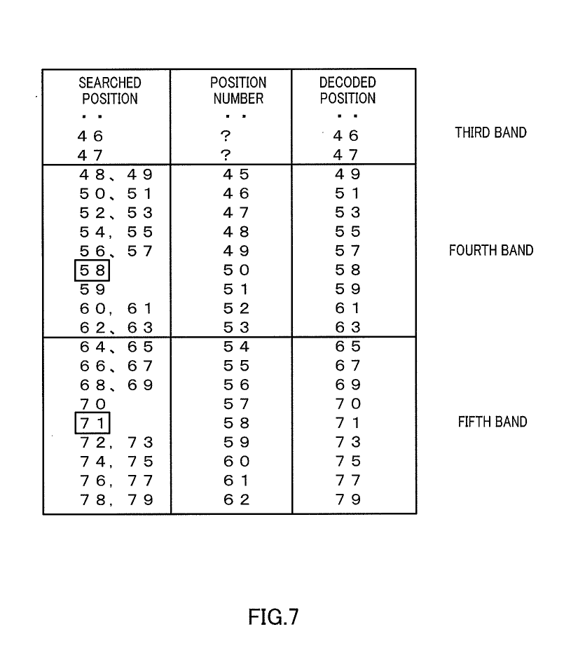

That is, although the number of variations of the first thorough pulse position decreases from 80 to 64 by halving the accuracy in two bands, positions around the positions of two pulses searched for in the two bands are found closely. Consequently, the number of variations increases by two and becomes “66.” With this method, it is possible to reduce the accuracy of position information of pulses in high bands without overlapping pulse positions. FIG. 7 shows coding results of the positions of pulses searched out by thorough search near the fourth and fifth bands when the band-specific pulse position is “58” in the fourth band and the band-specific pulse position is “71” in the fifth band.

The coding method of the position of the first pulse searched out by thorough search, includes the following steps.

(1) If the searched position is lower than “48,” processing is finished by encoding the value (hereinafter “position number”) of the position aligned to the left from the searched position by the number of band-specific pulses. For example, if the searched position is “35” and one pulse is placed in a position between 0 and 15 and in a position between 16 and 31 lower than position “35,” the position number is “35−2=33.” Here, “−1” is left as is.

(2) If the searched position is equal to or higher than “48,” “48” is subtracted from the searched position.

(3) the value of (2) is divided by “2” and added “45.”

(4) If the searched position is equal to or higher than “58” which represents “the decoding position of the position in the fourth band,” “1” is added to the value calculated in (3), and processing is finished.

(5) If the searched position is equal to or higher than “71” which represents “the decoding position of the position in the fifth band,” “1” is added to the value calculated in (4), and processing is finished.

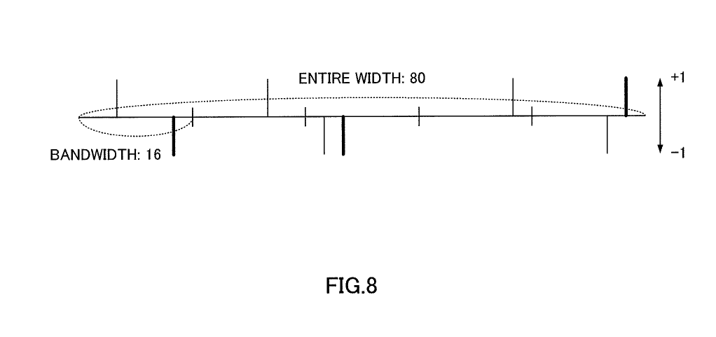

As described above, the number of entries of the first pulse position code is “64.” This is because a position in which a pulse is less preferable to be placed is also encoded as one position, and therefore the number of entries is increased by one from 63 in actual positions (as clear from FIG. 8, the position number is 0 to 62 in which pulses are present).

Also, the second pulse and the third pulse are encoded after deleting the previous pulse code from the entries and removing the value. That is, the number of entries of the second pulse is “63,” and the number of entries of the third pulse is “62.”

Next, the decoding method supporting coding will be described. Assume that this processing is performed in the speech decoding apparatus.

After decoding the band-specific position number (which is the value given by multiplying a code by “2,” adding “1” to the multiplication result and adding the addition result to the first position in the band), the speech decoding apparatus decodes the position of the first pulse searched out by thorough search, according to the following steps.

(1) “48” is subtracted from “59” which represents the “decoding position of the position in the fourth band,” and the subtraction result is divided by “2.”

(2) “48” is subtracted from “71” which represents the “decoding position of the position in the fifth band,” and the subtraction result is divided by “2.”

(3) If the position number is lower than “45,” it is decoded directly, and processing is finished. That is, the position is found taking into account the band-specific pulse position.

(4) If the position number is equal to or higher than “45,” “45” is subtracted from the position number.

(5) If the value calculated in (4) is equal to the value calculated in (1), the calculation of following (6) is performed, or, if the value calculated in (4) is equal to the value adding “1” to the value calculated in (1), the calculation of following (7) is performed. Otherwise, the calculation of following (8) is performed.

(6) The decoding value is given by doubling the value calculated in (4) and adding “48” to the result, the “decoding position of the position in the fourth band” is changed to “that decoding value +1,” and processing is finished.

(7) The decoding value is given by doubling the value calculated in (4) and adding “49” to the result, the “decoding position of the position in the fourth band” is changed to “that decoding value −1,” and processing is finished.

(8) “1” is further subtracted from the value of (4.)

(9) If the value calculated in (8) is equal to the value calculated in (2), the calculation of following (19) is performed, or, if the value calculated in (8) is equal to the value adding “1” to the value calculated in (2), the calculation of following (11) is performed. Otherwise, the calculation of following (12) is performed.

(10) The decoding value is given by doubling the value calculated in (8) and adding “48” to the result, the “decoding position of the position in the fifth band” is changed to “that decoding value +1,” and processing is finished.

(11) The decoding value is given by doubling the value calculated in (8) and adding “49” to the result, the “decoding position of the position in the fifth band” is changed to “that decoding value −1,” and processing is finished.

(12) “1” is further subtracted from the value of (8).

(13) The decoding value is given by doubling the value of (12) and adding “1” to the result, and processing is finished.

By performing the above processing, it is possible to decode the first pulse. As for the second pulse and the third pulse, by performing the above processing after changing the position number according to the position number of the previous pulse, for example, by adding “1” when the previous pulse code is exceeded, it is possible to perform decoding. Also, as for the position of “−1” where a pulse is not placed, the position is added to the entries to calculate the position number. This processing including “−1” will be described later upon explanation for coding of position numbers.

The present embodiment has described a case where: the input spectrum is 80 samples; 63 entries are provided as above by reducing the number of bits in two high frequency bands; and five pulses are placed in bands. Therefore, taking into account a “case where a pulse is not placed,” the number of variations of positions can be represented by sixteen bits as shown in following equation 2.

$$\begin{matrix}( Equation 2 ) & \\ \begin{matrix}{}_{62 + 1}^{}{C}{}_{3}^{} = ( 63 + 1 ) * ( 62 + 1 ) * ( 61 + 1 ) / 3 / 2 / 1 \\ = 41664 < 65536 \\ = {2}^{\hat{}} 16\end{matrix} & [ 2 ]\end{matrix}$$

Here, according to the rule of not allowing two or more pulses to be placed in the same position, it is possible to reduce the number of combinations, so that the effect of this rule becomes greater when the number of pulses searched out by thorough search increases.

The method of encoding position numbers acquired in the above coding will be described below in detail.

(1) Three pulse positions are sorted based on their magnitude and arranged in order from the lowest value to the highest value. Here, “−1” is left as is.

(2) “−1” is set to the position number represented by “the maximum pulse value +1.” In this case, the order of values is adjusted and determined not to confuse the set position number with the position number in which a pulse is actually present. By this means, the pulse number of pulse #0 is limited to the range between 0 and 61, the position number of pulse #1 is limited to the range between the position number of pulse #0 and 62, and the position number of pulse #2 is limited to the range between the position number of pulse #1 and 63, so that the position number of a lower pulse is designed not to exceed the position number of a higher pulse.

(3) Then, according to integration processing shown in following equation 3 to calculate a combination code, the position numbers (i0, i1, i2) are integrated to provide code (c). This integration processing is the calculation processing of integrating all combinations when there is an order of magnitude.

c=((64−0)*(65−0)*(129−2*0)/3+(62−0)*(63−0))/4((64−i0)*(65−i0)*(129−2*i0)/3+(62−i0)*(63−i0))/4;

c=c+(64−i0)*(65−i0)/2−(64−i1)*(65−i1)/2;

c=c+63−i2 (Equation 3)

(4) Then, by combining the sixteen bits of this c and the three bits for polarity, a code of twenty bits is provided.

Here, among the above-noted position numbers, “61” of pulse #0, “62” of pulse #1 and “63” of pulse #2 represent position numbers in which pulses are not placed. For example, if there are three position numbers (61, −1, −1), according to the above-noted relationship between a previous position number and a position number in which a pulse is not placed, these position numbers are reordered to (−1, 61, −1) and changed to (61, 61, 63).

Thus, with a model to represent an input spectrum by a sequence of eight pulses (five band-specific pulses and three pulses searched out by thorough search) as shown in this example, it is possible to perform coding by 42 information bits.

FIG. 8 shows an example of a spectrum represented by pulses searched out in interval search section 121 and thorough search section 122. Also, in FIG. 8, the pulses represented by bold lines are pulses searched out in thorough search section 122.

Gain quantizing section 112 quantizes the gain of each band. Eight pulses are placed in the bands, and gain quantizing section 112 calculates the gains by analyzing the correlation between these pulses and the input spectrum. An important point of this gain quantization algorithm is that the shape of the used pulse is not given by a pulse sequence decoding a code, but is given by the pulse sequence itself found by a pulse search on the encoding side. That is, a pulse position before coding is used. This is because, with the present invention, the accuracy of the positions of high frequency components is reduced, and the gains are not encoded correctly using decoded positions. The gains need to be encoded by pulses in correct positions.

When gain quantizing section 112 calculates ideal gains and then performs coding by scalar quantization (SQ) or vector quantization (VQ), first, gain quantizing section 112 calculates ideal gains according to following equation 4. Here, in equation 4, gⁿ is the ideal gain of band n, s(i+16n) is the input spectrum of band n, and vⁿ(i) is a vector acquired by decoding the shape of band n.

$$\begin{matrix}( Equation 4 ) & \\ {g}^{n} = \frac{{\sum }_{i} s ( i + 16 n ) \times {v}^{n} ( i )}{{\sum }_{i} {v}^{n} ( i ) \times {v}^{n} ( i )} & [ 4 ]\end{matrix}$$

Further, gain quantizing section 112 performs coding by performing scalar quantization of the ideal gains or by performing vector quantization of these five gains together. In the case of performing vector quantization, it is possible to perform efficient coding by prediction quantization, multi-stage VQ, split VQ, and so on. Here, perceptually, gain can be heard on a logarithmic scale, and, consequently, by performing SQ or VQ after performing logarithmic conversion of gain, it is possible to provide perceptually good synthesis sound.

Further, instead of calculating ideal gains, there is a method of directly evaluating coding distortion. For example, in the case of performing VQ of five gains, following equation 5 is minimized. Here, in equation 5, Eₖ is the distortion of the k-th gain vector, s(i+16n) is the input spectrum of band “n,” gₙ^{(k)} is the n-th element of the k-th gain vector, and vⁿ(i) is a shape vector acquired by decoding the shape of band “n.”

$$\begin{matrix}( Equation 5 ) & \\ {E}_{k} = {\sum }_{n} {\sum }_{i} \{ s ( i + 16 n ) - {g}_{n}^{( k )} {v}^{n} ( i ) \} & [ 5 ]\end{matrix}$$

Next, the method of decoding three pulses searched out by thorough search in spectrum decoding section 203 will be explained.

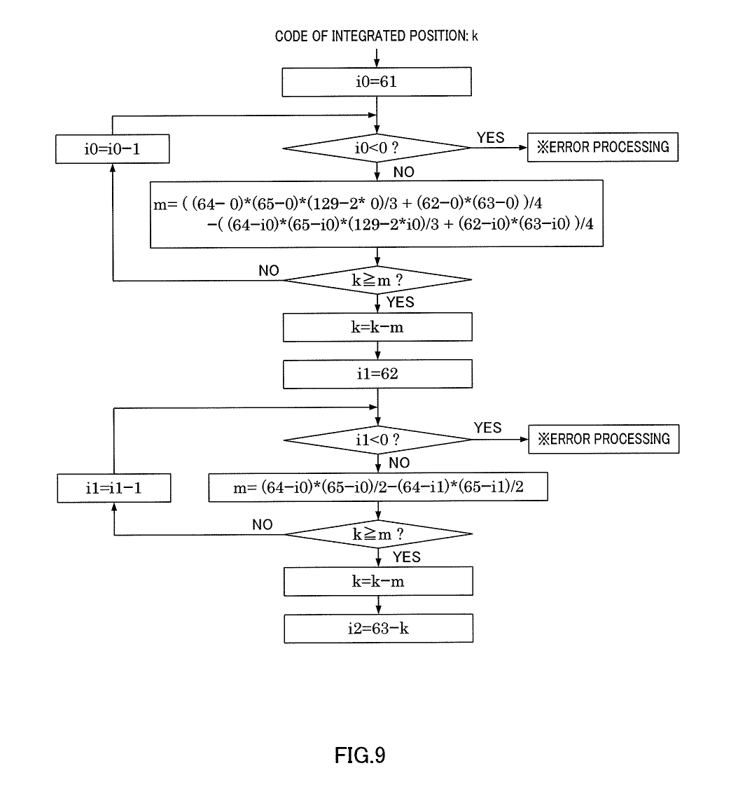

In thorough search section 122 of spectrum coding section 105, position numbers (i0, i1, i2) are integrated to one code using above equation 3. In spectrum decoding section 203, opposite processing is performed. That is, spectrum decoding section 203 performs decoding by sequentially performing calculations while changing individual position numbers, fixing the position numbers when the calculation results are lower than the value of the integration equation, and performing this processing from the lowest to the highest order in these position numbers. FIG. 9 is a flowchart showing the decoding algorithm of spectrum decoding section 203.

Further, in FIG. 9, when input code “k” of the integrated position is erroneous due to bit error, the flow proceeds to the step of error processing. Therefore, in this case, the position must be found by predetermined error processing.

Further, since the decoder has loop processing, the amount of calculations in the decoder is greater than in the encoder. Here, each loop is an open loop, and, consequently, as compared with the overall amount of processing in the codec, the amount of calculations in the decoder is not so large.

Thus, according to Embodiment 1, it is possible to accurately encode frequencies (positions) in which energy is present, so that it is possible to improve qualitative performance, which is unique to spectrum coding, and provide good sound quality even at a low bit rate.

Also, although two high frequency bands among five bands are set as the targets for reduced accuracy in above Embodiment 1, according to the present invention, the number of bands to reduce the accuracy is not limited. By selecting a band in advance in which the difference of frequencies is not sensed perceptually, determining bands to reduce the accuracy, and applying the present invention to these bands, it is possible to encode/decode speech of high quality with a limited number of bits. Also, when a band to encode speech signals is wider in the high frequency domain, the number of bands to reduce the accuracy increases.

Also, although a method is employed with Embodiment 1 where two positions are used as one position in which the accuracy is reduced to half and positions to be decoded are fixed to odd-numbered positions, the present invention does not depend on positions to fix (i.e. even-numbered positions or odd-numbered positions) and the degree of reducing accuracy. It is equally possible to fix the positions to be decoded to even-numbered positions when the accuracy is reduced to half, and it is equally possible to set higher frequency bands such that the accuracy is reduced to one third or one fourth. For example, in the case where the accuracy is reduced to one third, the present invention provides an advantage in any of cases where: the reminder dividing the value of the position to fix by 3 is 0; the reminder dividing the value by 3 is 1; and the reminder dividing the value by 3 is 2. Also, when a band to encode speech signals is wider in the high frequency domain, it is possible to further reduce the accuracy.

Also, although the condition of not placing two pulses in the same position is set in above Embodiment 1, the present invention may partly relax this condition. For example, if a pulse searched per band and a pulse searched in a wide interval over a plurality of bands are allowed to be placed in the same position, it is possible to cancel the band-specific pulse or place a pulse of double amplitude. To relax that condition, an essential requirement is not to store pulse presence/non-presence flag pf[*] with respect to a band-specific pulse. That is, “pf[pos[b]]=1” in the last step in FIG. 5 can be omitted. Alternatively, another method of relaxing that condition is not to store a pulse presence/non-presence flag upon a pulse search in a wide interval. That is, “pf[idx_max[i+5]]=1” in the last step in FIG. 6 can be omitted. In this case, the number of variations of positions increases. The combinations are not as simple as shown in the present embodiment, and therefore it is necessary to classify cases and encode the combinations for each of the classified cases.

### Embodiment 2

The configuration of a speech coding apparatus according to Embodiment 2 of the present invention is the same as the configuration of Embodiment 1 shown in FIG. 1, and the configuration of a speech decoding apparatus according to Embodiment 2 of the present invention is the same as the configuration of Embodiment 1 shown in FIG. 2. Therefore, the different functions in these configurations will be explained using FIG. 1 and FIG. 2.

In the speech coding apparatus according to Embodiment 2 of the present invention, shape quantizing section 111 of spectrum coding section 105 will be explained in detail. Shape quantizing section 111 is provided with interval search section 121 that searches for pulses in each of a plurality of bands into which a predetermined search interval is divided, and thorough search section 122 that searches for pulses over the entire search interval.

Equation 1 provides the reference of search as shown in Embodiment 1, and, from equation 1, the pulse position to minimize the cost function refers to a position in which the absolute value |sₚ| of the input spectrum in each band is maximum, and the polarity refers to a polarity of the input spectrum value in the position of that pulse.

An example case will be explained below where the vector length of an input spectrum is eighty samples and the number of bands is five, and where the spectrum is encoded using eight pulses in total, one pulse from each band and three pulses from the entire band. In this case, the length of each band is sixteen samples. Further, the amplitude of pulses to search for is fixed to “1,” and their polarity is “+” or “−.”

Also, upon shape coding, the number of bits is saved by reducing the accuracy of pulse positions in two high frequency bands. To be more specific, although coding is performed in all positions, positions in the two high frequency bands are limited to “odd-numbered” positions in decoding. Here, in a case where a pulse is already present upon decoding, a case is possible where a pulse is placed in an even-numbered position.

Also, in three low frequency bands, pulse positions are searched for at fractional accuracy, and encoded at reduced integral accuracy. At this time, the value acquired in a pulse position at fractional accuracy is used as an ideal gain, and the integral value closest to the pulse position at the fractional accuracy is used to encode the pulse position. By this means, it is possible to find an ideal gain of a more accurate value, and, compared to a case of performing a search only in integral positions, find decoded speech of higher quality. With the present embodiment, the amount of calculations is reduced using a fractional accuracy of ⅓ and a seventh-order interpolation function.

Interval search section 121 searches for the position of the maximum energy and the polarity (+/−) in each band, and places one pulse per band. In this example, the number of bands is five, and each band requires four bits (entries of positions: sixteen)×three bands+three bits (entries of positions: eight)×two bands to show the pulse position and one bit to show the polarity (+/−), requiring twenty three information bits in total. Also, if the accuracy in the high frequency bands is not reduced, it requires five (bands)×(four (position) and one (polarity))=twenty-five information bits. Therefore, according to this example, it is possible to save two bits compared to a case of not reducing the accuracy in high frequency bands. Also, up to fractional positions are searched for at integral accuracy in the three low frequency bands, so that it is possible to save four bits.

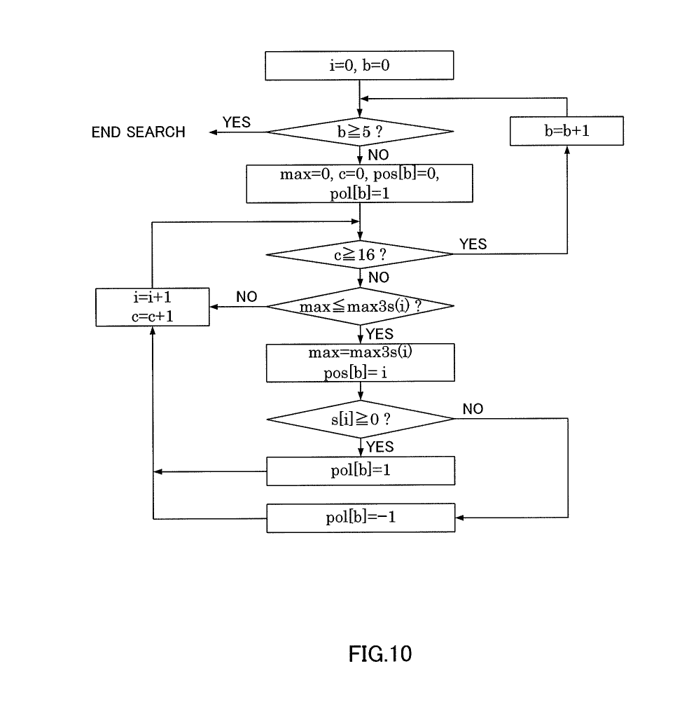

The flow of a search algorithm of interval search section 121 is shown in FIG. 10. Here, in the content of the symbols used in the flowchart of FIG. 10 including the symbols used in the flow of FIG. 3, max3s(i) stands for a function to output the maximum absolute value of s[i] searched out in a position of fractional accuracy near position i. Also, max3s(i) is represented by following equation 76.

$$\begin{matrix}( Equation 6 ) & \\ max 3 s ( i ) = max \{ \begin{matrix}\vert s [ i ] \vert \\ \vert {\sum }_{j = - 3}^{3} {ɛ}_{j}^{- 1 / 3} \cdot s [ i + j ] \vert \\ \vert {\sum }_{j = - 3}^{3} {ɛ}_{j}^{1 / 3} \cdot s [ i + j ] \vert\end{matrix} & [ 6 ]\end{matrix}$$

is integral position
i-⅓: fractional position
i+⅓: fractional position

In equation 6, interpolation functions εⱼ^{-1/3} and εⱼ^{1/3} are calculated from a sinc function, circumference ratio, and so on. The order of the interpolation function is seven, and this example is shown in following equation 7.

j−3−2−1 0 1 2 3 εⱼ^{1/3}={−0.0256368,0.0694773,−0.1752813,0.8186803,0.3970523,−0.1273570,0.0508515}εⱼ^{-1/3}={0.0508515,−0.1273570,0.3970523,0.8186803,−0.1752813,0.0694773,−0.0256368} (Equation 7)

After coding is performed according to the above algorithm, the result of subtracting the value of the first position in each band from pos[b] (i.e. a value between 0 and 15) is used as a position code (four bits). In two high frequency bands, the result of dividing the same value by 2 (i.e. a value between 0 and 7) is used as a position code (three bits).

Although an optimal pulse is placed in each band with the above model, as a result, pulses are placed in the most important positions as a whole. This is based on an idea that, if there are a small number of information bits for encoding a spectrum, it is possible to provide perceptually better sound quality by placing pulses accurately in positions of energy than by decoding a vector of a similar shape.

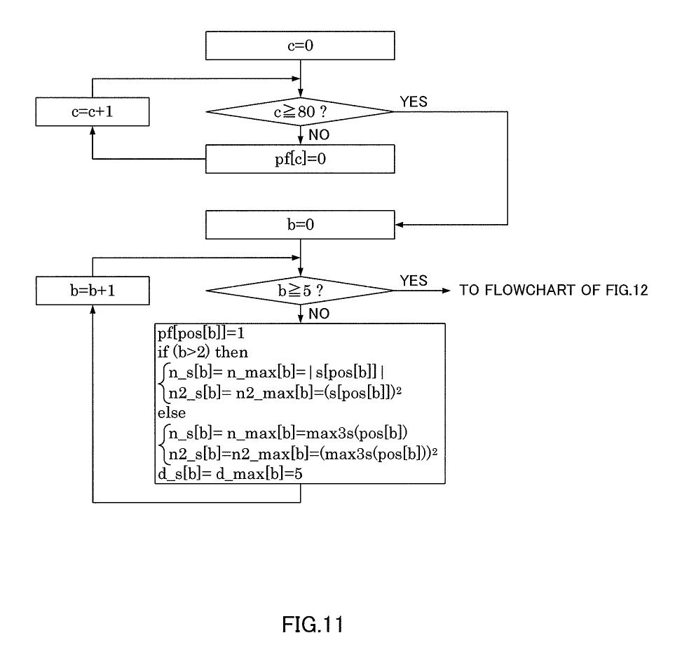

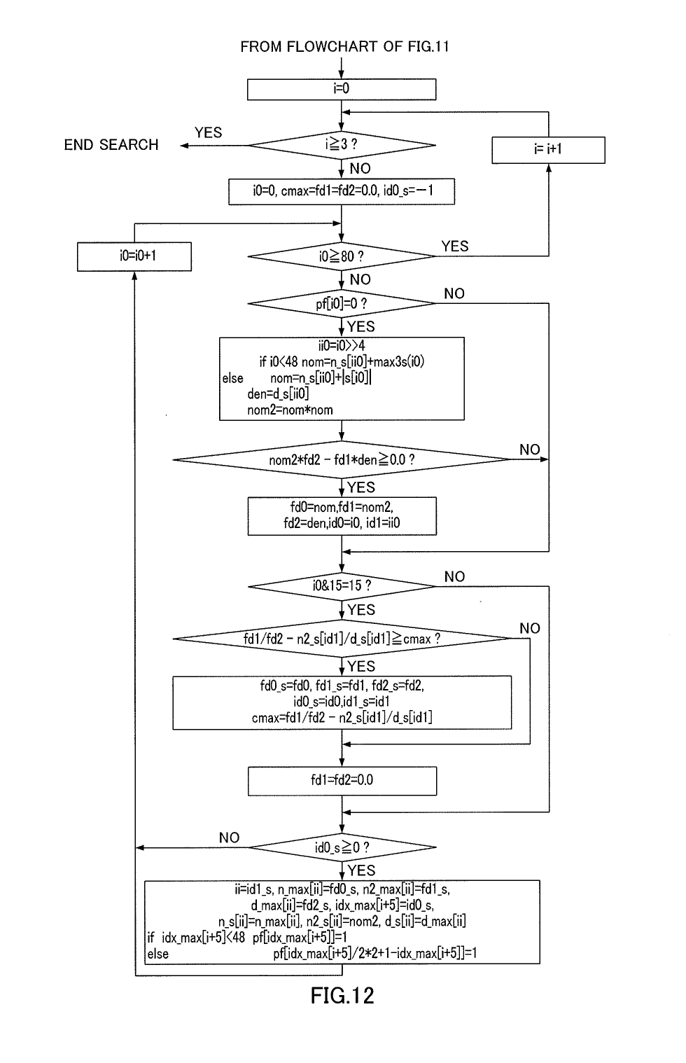

Next, the flow of the search algorithm in thorough search section 122 is shown in FIG. 11. FIG. 11 is a flowchart of preprocessing of a search, and FIG. 12 is a flowchart of the search.

In the symbols used in the flowchart of FIG. 11 including the symbols used in the flow of FIG. 5, max3s(i) stands for a function to output the maximum absolute value of s[i] searched out in a position of fractional accuracy near position i. Also, the content of the symbols used in the flow of FIG. 12 further includes max3s(i) in addition to the symbols used in the flow of FIG. 6.

Here, in the flows of FIG. 11 and FIG. 12, although function max3s(i) to output the maximum absolute value in fractional accuracy is used, this value is once calculated upon a pulse search per band in FIG. 10.

Consequently, by storing the value in a memory (such as an RAM) of a size of 48 upon a search per band and using this value with the algorithm, it is possible to omit calculations of the above function.

Next, although the pulse positions and polarities searched out by the above algorithm are encoded, the content is the same as the content already explained in Embodiment 1, and therefore its explanation will be omitted.

Gain quantizing section 112 is different from that of Embodiment 1 in the way of finding an ideal gain. That is, in three low frequency bands, ideal gains represent the maximum amplitudes of the input spectrum of a pulse searched out at fractional accuracy. With the present embodiment, in a case of finding an ideal gain and encoding it by scalar quantization or vector quantization, first, the ideal gain is found by following equation 8. Here, in equation 8, gⁿ is the ideal gain of band n, s(i+16n) is the input spectrum of band n, vⁿ(i) is a vector acquired by decoding the shape of band n, and sm×3(i+16n) is the value of the maximum amplitude among the values searched out at fractional accuracy in position i+16.

$$\begin{matrix}( Equation 8 ) & \\ if n < 3 then \\ {g}^{n} = \frac{{\sum }_{i} s ( i + 16 n ) \cdot {v}^{n} ( i )}{{\sum }_{i} {v}^{n} ( i ) \cdot {v}^{n} ( i )} \\ else \\ {g}^{n} = \frac{{\sum }_{i} smx 3 ( i + 16 n ) \cdot {v}^{n} ( i )}{{\sum }_{i} {v}^{n} ( i ) \cdot {v}^{n} ( i )} & [ 8 ]\end{matrix}$$

In above equation 8, function sm×3(i+16n) is acquired by adding a polarity to max3s(i+16n). Therefore, with the algorithm to find actually, the polarity is stored while finding the maximum amplitude, and the amplitude upon output is multiplied by the polarity. When describing this by a function, the result is as following equation 9.

$$\begin{matrix}( Equation 9 ) & \\ smx 3 s ( i ) = \{ \begin{matrix}s [ i ] & if max 3 s ( i ) = \vert s ( i ) \vert \\ {\sum }_{j = - 3}^{3} {ɛ}_{j}^{- 1 / 3} \cdot s [ i + j ] & if max 3 s ( i ) = \vert {\sum }_{j = - 3}^{3} {ɛ}_{j}^{- 1 / 3} \cdot s [ i + j ] \vert \\ {\sum }_{j = - 3}^{3} {ɛ}_{j}^{1 / 3} \cdot s [ i + j ] & if max 3 s ( i ) = \vert {\sum }_{j = - 3}^{3} {ɛ}_{j}^{1 / 3} \cdot s [ i + j ] \vert\end{matrix} & [ 9 ]\end{matrix}$$

Also, instead of calculating ideal gains, there is a method of directly evaluating coding distortion. For example, in the case of performing VQ of five gains, following equation 5 is minimized. Here, in equation 10, Eₖ is the distortion of the k-th gain vector, s(i+16n) is the input spectrum of band “n,” gₙ^{(k)} is the n-th element of the k-th gain vector, and vⁿ(i) is a shape vector acquired by decoding the shape of band “n.”

$$\begin{matrix}( Equation 10 ) & \\ {E}_{k} = {\sum }_{n = 0}^{2} {\sum }_{i} \{ smx 3 ( i + 16 n ) - {g}_{n}^{( k )} {v}^{n} ( i ) \} + {\sum }_{n = 3}^{4} {\sum }_{i} \{ s ( i + 16 n ) - {g}_{n}^{( k )} {v}^{n} ( i ) \} & ( Equation 10 )\end{matrix}$$

With encoded information transmitted from the above speech coding apparatus, in spectrum decoding section 203 of the speech decoding apparatus according to Embodiment 2 of the present invention, information of each shape and gain is extracted according to the algorithm in spectrum coding section 105 of the speech coding apparatus, and decoding is performed by multiplying a decoded shape vector by a decoded gain. Here, the method of decoding the positions of three pulses searched out by thorough search upon shape decoding has been explained with Embodiment 1, and therefore its explanation will be omitted.

Thus, according to Embodiment 2, it is possible to extract accurate spectral values by a search taking into account pulse positions of fractional accuracy in low frequency bands, so that it is possible to improve sound quality. Therefore, it is possible to efficiently encode a frequency-converted spectrum at a low bit rate and provide high sound quality even at a low bit rate.

Also, although the fractional accuracy is ⅓ with the present embodiment, it is equally possible to adopt ½, ¼ or another fractional accuracy. This is because the content of the present invention does not depend on the measurement of accuracy.

Also, although the product sum of the function for calculating the value of fractional accuracy has the seventh order in the present embodiment, any order is possible. This is because the content of the present invention does not depend on the order. Here, although the accuracy becomes higher when the order increases, in contrast, the amount of calculations increases.

Further, although a case has been described above with the present embodiment where gain coding is performed after shape coding, the present invention can provide the same performance if shape coding is performed after gain coding. Further, it may be possible to employ a method of performing gain coding on a per band basis and then normalizing the spectrum by decoded gains, and performing shape coding of the present invention.

Further, an example case has been described above with the present embodiment where, upon quantization of a spectral shape, the length of the spectrum is eighty samples, the number of bands is five, the number of pulses to search for per band is one and the number of pulses to search for in the entire interval is three. However, the present invention does not depend on the above values at all and can provide the same effects with different values.

Further, although a search of “pulses” has been described above with embodiments, it is equally possible to search for “fixed waveforms” such as dual pulse (pair of two pulses) and pulses in fractional positions (SINC function waveform). If a fixed waveform is provided, the present invention is applicable in the same way as above.

Further, if the bandwidth is sufficiently fine, relatively many gains can be encoded and the number of information bits is sufficiently large, the present invention can achieve the above performance only by performing a pulse search on a per band basis or only by performing a pulse search in a wide interval over a plurality of bands.

Further, although pulse coding is performed for a spectrum subjected to an orthogonal transform in the above embodiments, the present invention is not limited to this, and is also applicable to other vectors. For example, the present invention may be applied to complex-number vectors in the FFT or complex DCT, and may be applied to a time domain vector sequence in the Wavelet transform or the like. Further, the present invention is also applicable to a time domain vector sequence such as excitation waveforms of CELP. As for excitation waveforms in CELP, a synthesis filter is involved, and therefore a cost function involves a matrix calculation. Here, the performance is not sufficient by a search in an open loop when a filter is involved, and therefore some closed loop search needs to be performed. When there are many pulses, it is effective to use a beam search or the like to reduce the amount of calculations.

Further, according to the present invention, a waveform to search for is not limited to a pulse (impulse), and it is equally possible to search for other fixed waveforms (such as dual pulse, triangle wave, finite wave of impulse response, filter coefficient and fixed waveforms that change the shape adaptively), and provide the same effect.

Further, although a case has been described with the preset embodiment where the present invention is applied to CELP, the present invention is not limited to this but is effective with other codecs.

Further, not only speech signals but also audio signals can be used as the signals according to the present invention. It is also possible to employ a configuration in which the present invention is applied to an LPC prediction residual signal instead of an input signal.

Also, although cases have been described with the above embodiments where the decoding apparatus receives and processes encoded information transmitted from the coding apparatus, the present invention is not limited to this, and an essential requirement is that the decoding apparatus can receive and process encoded information as long as this encoded information is transmitted from a coding apparatus that can generate encoded information that can be processed by that decoding apparatus.

The coding apparatus and decoding apparatus according to the present invention can be mounted on a communication terminal apparatus and base station apparatus in a mobile communication system, so that it is possible to provide a communication terminal apparatus, base station apparatus and mobile communication system having the same operational effect as above.

Although example cases have been described with the above embodiments where the present invention is implemented with hardware, the present invention can be implemented with software. For example, by describing the algorithm according to the present invention in a programming language, storing this program in a memory and running this program by the information processing section, it is possible to implement the same function as the coding apparatus and decoding apparatus according to the present invention.

Furthermore, each function block employed in the description of each of the aforementioned embodiments may typically be implemented as an LSI constituted by an integrated circuit. These may be individual chips or partially or totally contained on a single chip.

“LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells in an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosures of Japanese Patent Application No. 2008-101177, filed on Apr. 9, 2008, and Japanese Patent Application No. 2008-292626, filed on Nov. 14, 2008 including the specifications, drawings and abstracts, are incorporated herein by reference in their entireties.

### INDUSTRIAL APPLICABILITY

The present invention is suitable to a coding apparatus that encodes speech signals and audio signals, and a decoding apparatus that decodes these encoded signals.

1. A coding apparatus comprising:
a shape quantizing section that encodes a shape of a frequency spectrum; and
a gain quantizing section that encodes a gain of the frequency spectrum,
wherein the shape quantizing section comprises:
an interval search section that searches for a first waveform in each of a plurality of bands dividing a predetermined search interval, and
encodes the first waveform searched out in a predetermined band, by a smaller number of bits than other first waveforms; and
a thorough search section that searches for a second waveform over the predetermined search interval, and, when the second waveform located in the predetermined band satisfies a predetermined condition, encodes a position near a position of the second waveform located in the predetermined band.

2. The coding apparatus according to claim 1, wherein the thorough search section searches for the second waveform while evaluating a coding distortion by a band-specific ideal gain.

3. The coding apparatus according to claim 1, wherein the thorough search section calculates a plurality of values using a plurality of items of position information related to the second waveform, and encodes position information related to the second waveform using the plurality of values.

4. The coding apparatus according to claim 1, wherein the thorough search section encodes position information of the second waveform located in the predetermined band, such that positions before and after the first waveform searched out in the predetermined band can be distinguished.

5. The coding apparatus according to claim 1, wherein the gain quantizing section calculates and encodes gains of the first waveform and the second waveform on a per band basis.

6. The coding apparatus according to claim 1, wherein the interval search section performs a search at fractional accuracy in a low frequency band among the plurality of bands dividing the predetermined search interval, and encodes position information showing a position of the fractional accuracy in a searched waveform by a position of integral accuracy closest to the position of the fractional accuracy.

7. The coding apparatus according to claim 6, wherein the gain quantizing section encodes a gain of a waveform in the position of the fractional accuracy of the searched waveform.

8. A coding method comprising:
a shape quantizing step of encoding a shape of a frequency spectrum; and
a gain quantizing step of encoding a gain of the frequency spectrum,
wherein the shape quantizing step comprises:
an interval search step of searching for a first waveform in each of a plurality of bands dividing a predetermined search interval, and encoding the first waveform searched out in a predetermined band, by a smaller number of bits than other first waveforms; and
a thorough search step of searching for a second waveform over the predetermined search interval, and, when the second waveform located in the predetermined band satisfies a predetermined condition, encodes a position nearby a position of the second waveform located in the predetermined band.
